(19) United States
(12) Patent Application Publication
(10) Pub. No.: US 2012/0089917 A1
(43) Pub. Date: Apr. 12, 2012

(54) METHOD FOR PROVIDING A GUI IN WHICH THE CONNECTION RELATIONSHIPS AND THE ARRANGEMENT OF DEVICES ARE SHOWN, AND DEVICE ADOPTING SAME

(75) Inventors: Ji-Young Kwahk, Gyeonggi-do (KR); Giang-Yoon Kwon, Seoul (KR); Jin-Young Jeon, Seoul (KR); Sang-Woong Hwang, Gyeonggi-do (KR); Jee-Sun Yoon, Seoul (KR)

(73) Assignee: SAMSUNG ELECTRONICS CO., LTD., Gyeonggi-do (KR)

(21) Appl. No.: 13/377,385

(22) PCT Filed: Jun. 9, 2010
(86) PCT No.: PCT/KR2010/003703

§ 371 Date: Dec. 9, 2011

(30) Foreign Application Priority Data
Jun. 9, 2009 (KR) 10-2009-0050852

(51) Int. Cl. G06F 15/177; G06F 3/01

(52) U.S. Cl. 715/735; 715/734

(57) ABSTRACT

A method and device for providing a Graphic User Interface (GUI) that displays connections between a plurality of devices and an arrangement of the plurality of devices, by determining connections between a plurality of devices and an arrangement between the plurality of devices; generating a GUI that displays the devices, the connections between the devices and the arrangement of the devices; and displaying the generated GUI, making it possible for a user to easily and intuitively determine the connections and arrangement of the devices that are connected to a network.

### PRIORITY

This application is a National Phase Entry of PCT International Application No. PCT/KR2010/003703, which was filed Jun. 9, 2010, and claims priority to Korean Patent Application No. 10-2009-0050852, which was filed in the Korean Intellectual Property Office, on Jun. 9, 2009, the content of which is incorporated herein by reference.

### BACKGROUND OF THE INVENTION

1. Field of the Invention

The present invention relates generally to a method of providing a Graphic User Interface (GUI) and a device to which the method is applied, and more particularly, to a method of providing a GUI that allows a user to acquire information therefrom and to enter a command based on the acquired information and a device to which the method is applied.

2. Description of the Related Art

Recent developments in network technology have opened the way for many devices to be connected to a network and to operate in connection with one another, and have enabled a variety of convenient services.

Specifically, user convenience has improved through various techniques that allow devices to transmit/receive data to/from each other via a network and enable various commands to be entered indirectly to devices via other devices.

However, when too many devices connected to a network, it may be difficult to properly manage the devices and identify each of the devices.

### SUMMARY OF THE INVENTION

Accordingly, the present invention has been made to solve the above-stated problems occurring in the prior art, and provides a Graphic User Interface (GUI) that displays the connections between devices and the pattern of the arrangement of the devices to help a user identify the devices easily and intuitively.

According to an aspect of the present invention, there is provided a method of providing a Graphic User Interface (GUI), including determining connections between a plurality of devices and the arrangement of the plurality of devices; generating a GUI that displays the devices, the connections between the devices and the arrangement of the devices; and displaying the generated GUI.

According to another aspect of the present invention, there is provided a device for providing a Graphic User Interface (GUI) including a controller for determining connections between a plurality of devices and arrangement of the plurality of devices, generating a GUI that displays the plurality of devices, the connections between the devices and the arrangement of the devices, and a display for displaying the generated GUI.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a diagram illustrating an example of determining the orientations of table-top devices that are located in vicinity thereof, according to an embodiment of the present invention;

FIG. 2 is a diagram illustrating a table showing a connection/arrangement list stored by a table-top device, according to an embodiment of the present invention;

FIGS. 3 to 5 are diagrams illustrating an example of automatically generating and providing a connection/arrangement map using a connection/arrangement map window, according to an embodiment of the present invention;

FIG. 6 is a diagram illustrating an automatic connection resetting function, according to an embodiment of the present invention;

FIGS. 7 to 10 are diagrams illustrating an example of manually disconnecting table-top devices, according to an embodiment of the present invention;

FIGS. 11 to 14 are diagrams illustrating an example of manually setting connections between table-top devices, according to an embodiment of the present invention;

FIGS. 15 and 16 are diagrams illustrating an example of manually changing the arrangement of table-top devices on a connection/arrangement map, according to an embodiment of the present invention;

FIGS. 17 and 18 are diagrams illustrating an example of transmitting content using a connection/arrangement map, according to an embodiment of the present invention;

FIGS. 19 to 22 are diagrams illustrating an example of displaying or deleting connection lines, according to an embodiment of the present invention;

FIGS. 23 and 24 are diagrams illustrating an example of adjusting the size of a connection/arrangement map, according to an embodiment of the present invention;

FIG. 25 is a diagram illustrating an example of calling a connected device list, according to an embodiment of the present invention;

FIG. 26 is a diagram illustrating an example of printing content using a connected device list that is provided along with a connection/arrangement map, according to an embodiment of the present invention;

FIG. 27 is a diagram illustrating an example of storing a connection/arrangement map, according to an embodiment of the present invention;

FIG. 28 is a block diagram of a device, according to an embodiment of the present invention; and

FIG. 29 is a flowchart illustrating an operation of the device illustrated in FIG. 28, according to an embodiment of the present invention.

### DETAILED DESCRIPTION OF THE EMBODIMENTS OF THE PRESENT INVENTION

Various embodiments of the present invention will be described in detail with reference to the accompanying drawings. It will be apparent to those of ordinary skill in the art that the present invention may be embodied in various forms and should not be construed as limited to the embodiments described herein. Throughout the drawings, the size and relative sizes of layers and regions may be exaggerated for clarity and like reference numerals may refer to like elements, features and structures.

The present invention provides a connection and arrangement map that displays the connections between and the orientations of multiple devices as a GUI. More specifically, the present invention is directed toward establishing information for generating a connection and arrangement map, providing a connection and arrangement map, editing a connection and arrangement map, providing various application functions using a connection and arrangement map, and providing additional functions using a connection and arrangement map.

Automatically generating and providing a connection and arrangement map and providing an automatic connection resetting function will be presented as examples of providing a connection and arrangement map; manually connecting or disconnecting devices and manually changing the arrangement of devices will be presented as examples of editing a connection and arrangement map; transmitting and printing content using a connection and arrangement map will be presented as examples of providing various applications using a connection and arrangement map; and displaying and deleting connection lines, enlarging and reducing a connection and arrangement map, providing a connected device list, and storing a connection and arrangement map will be presented as examples of providing additional functions using a connection and arrangement map.

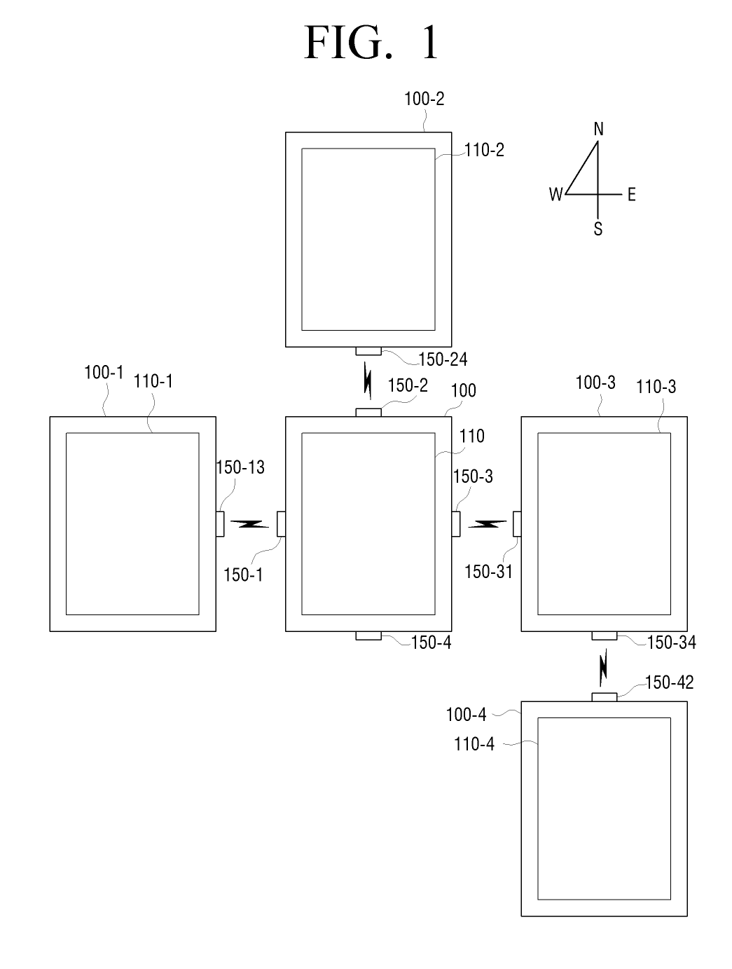

FIG. 1 is a diagram illustrating an example of determining the orientations of table-top devices that are located in vicinity thereof. FIG. 1 illustrates a plurality of table-top devices 100, 100-1, 100-2, 100-3, and 100-4.

The table-top devices 100, 100-1, 100-2, 100-3, and 100-4 may be connected to be able to communicate with one another via a network, wherein the network may be a wired or wireless network. Therefore, the table-top devices 100, 100-1, 100-2, 100-3, and 100-4 may transmit data to or receive data from one another. The table-top devices 100, 100-1, 100-2, 100-3, and 100-4 may be “directly” or “indirectly” connected to one another.

For example, the table-top device 100 may be “directly” connected to the first, second, and third table-top devices 100-1, 100-2, and 100-3, but may not be “directly” connected to the fourth table-top device 100-4.

Here, if the third table-top device 100-3 is “directly” connected to the fourth table-top device 100-4, the table-top device 100 may be connected “indirectly” to the fourth table-top device 100-4 via the third table-top device 100-3.

Each of the table-top devices 100, 100-1, 100-2, 100-3 and 100-4 includes a touch screen provided at the top thereof and one or more InfraRed (IR) transceivers provided on the sides thereof. That is, the table-top device 100 includes a touch screen 110 and IR transceivers 150-1 to 150-4; the first table-top device 100-1 includes a touch screen 110-1 and an IR transceiver 150-13; the second table-top device 100-2 includes a touch screen 110-2 and an IR transceiver 150-24; the third table-top device 100-3 includes a touch screen 110-3 and IR transceivers 150-31 and 150-34; and the fourth table-top device 100-4 includes a touch screen 110-4 and an IR transceiver 150-42.

The IR transceivers 150-1 to 150-4, 150-13, 150-24, 150-31, 150-34 and 150-42 may be used for IR communications between the table-top devices 100, 100-1, 100-2, 100-3 and 100-4. More specifically, the IR transceivers of a pair of table-top devices that face each other may communicate through IR communication with each other.

For example, the IR transceiver 150-1, which is disposed on the west side of the table-top device 100, may communicate through IR communication with the IR transceiver 150-13, which is disposed on the east side of the first table-top device 100-1.

Through IR communications, the table-top devices 100, 100-1, 100-2, 100-3 and 100-4 may exchange their IDs with one another. More specifically, the IR transceiver 150-1 may transmit the ID of the table-top device 100, i.e., ID_#0, to the IR transceiver 150-13, and the IR transceiver 150-13 may transmit the ID of the first table-top device 100-1, i.e., ID_#1, to the IR transceiver 150-1.

The exchange of IDs through IR communications may also be performed between the IR transceiver 150-2 and the IR transceiver 150-24, between the IR transceiver 150-3 and the IR transceiver 150-31, and between the IR transceiver 150-34 and the IR transceiver 150-42.

The table-top device 100 may determine that the first table-top device 100-1 is located on its west side based on ID_#1, which is received from the IR transceiver 150-13 via the IR transceiver 150-1; may determine that the second table-top device 100-2 is located on its north side based on ID_#2, which is received from the IR transceiver 150-24 via the IR transceiver 150-1; and may determine that the third table-top device 100-3 is located on its east side based on ID_#3, which is received from the IR transceiver 150-31 via the IR transceiver 150-1.

Similarly, the first table-top device 100-1 may determine that the table-top device 100 is located on its east side based on ID_#0, which is received from the IR transceiver 150-1 via the IR transceiver 150-13, and the second table-top device 100-2 may determine that the table-top device 100 is located on its south side based on ID_#0, which is received from the IR transceiver 150-2 via the IR transceiver 150-24.

Similarly, the third table-top device 100-3 may determine that the table-top device 100 is located on its west side based on ID_#0, which is received from the IR transceiver 150-3 via the IR transceiver 150-31; and may determine that the fourth table-top device 100-4 is located on its south side based on ID_#4, which is received from the IR transceiver 150-42 via the IR transceiver 150-34.

Accordingly, the table-top devices 100, 100-1, 100-2, 100-3, and 100-4 may locate and identify their respective neighboring table-top devices.

The table-top devices 100, 100-1, 100-2, 100-3, and 100-4 may share their neighboring table-top device location information with one another. Accordingly, the table-top devices 100, 100-1, 100-2, 100-3, and 100-4 may identify not only their direct neighboring table-top devices but also their indirect neighboring table-top devices.

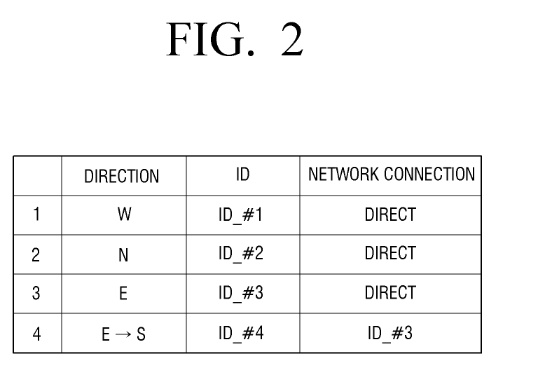

The table-top devices 100, 100-1, 100-2, 100-3, and 100-4 may generate and maintain a connection/arrangement table regarding all the table-top devices that constitute a network. An example of a connection/arrangement table that may be stored by the table-top device 100 is illustrated in FIG. 2.

Referring to FIG. 2, entry 1 indicates that the first table-top device 100-1, which is directly connected to the table-top device 100 via a network and corresponds to ID_#1, is located on the west side of the table-top device 100; entry 2 indicates that the second table-top device 100-2, which is directly connected to the table-top device 100 via a network and corresponds to ID_#2, is located on the north side of the table-top device 100; and entry 3 indicates that the third table-top device 100-3, which is directly connected to the table-top device 100 via a network and corresponds to ID_#3, is located on the east side of the table-top device 100.

Entry 4 indicates that the fourth table-top device 100-4, which is indirectly connected to the table-top device 100 via the third table-top device 100-3 and corresponds to ID_#4, is located on the south side of the table-top device 100.

The connection/arrangement table illustrated in FIG. 2 may be used to automatically generate a connection/arrangement map, which will be described in detail.

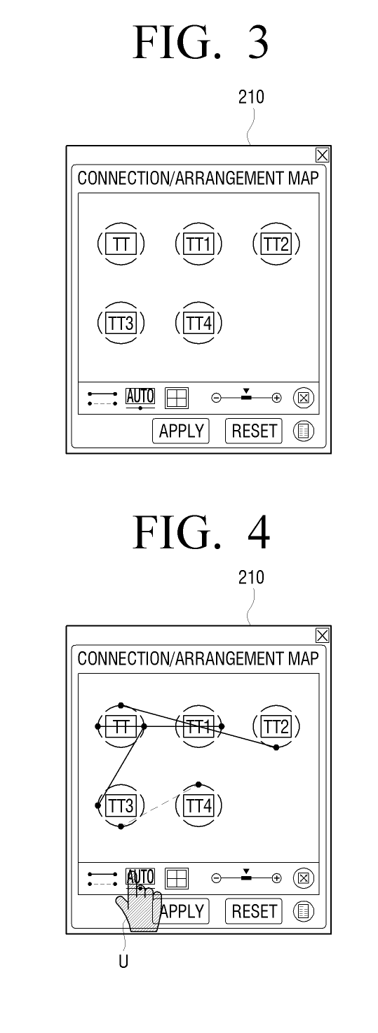

FIGS. 3 to 5 are diagrams illustrating examples of generating a connection/arrangement map using a connection/arrangement map window and providing the generated connection/arrangement map to a user.

Referring to FIG. 3, in response to the execution of a connection/arrangement map program installed in the table-top device 100, a connection/arrangement map window 210 may be provided. A plurality of table-top devices TT, TT1, TT2, TT3, and TT4 may be displayed in the connection/arrangement map window 210 as icons.

Each of the icons may be encircled by four outlines that represent the four sides of a corresponding table-top device.

The table-top device TT may correspond to the table-top device in which the connection/arrangement map program is executed, and the table-top devices TT1, TT2, TT3, and TT4 may correspond to the table-top devices 100, 100-1, 100-2, 100-3, and 100-4, respectively, that are listed in the connection/arrangement table of FIG. 2.

Referring to FIG. 4, if a user U touches on an ‘AUTO’ icon, which is an automatic connection/arrangement icon, one or more connection lines that connect the table-top devices TT, TT1, TT2, TT3, and TT4 may appear.

Each of the connection lines may be drawn from one of the four outlines of a table-top device to one of the four outlines of another table-top device with reference to the connection/arrangement table of FIG. 2.

Referring to FIG. 2, the first table-top device TT1 is located on the west side of the table-top device TT, i.e., the table top device TT is located on the east side of the first table-top device TT-1. Accordingly, the east side of the table-top device TT and the west side of the first table-top device TT1 may face each other.

Therefore, a connection line may be drawn between the left outline of the table-top device TT and the right outline of the first table-top device TT1.

Similarly, a connection line may be drawn between the upper outline of the table-top device TT and the lower outline of the second table-top device TT2, and a connection line may be drawn between the right outline of the table-top device TT and the left outline of the third table-top device TT3.

Referring to entry 4 of the connection/arrangement table of FIG. 2, the fourth table-top device TT4, which corresponds to ID_#4, is located on the south side of the third table-top device TT3, which is located on the east side of the table-top device TT, i.e., the third table-top device TT3 is located on the north side of the third table-top device TT3. Accordingly, a connection line may be drawn between the lower outline of the third table-top device TT3 and the upper outline of the fourth table-top device TT4.

Referring to FIG. 4, the connection lines drawn between the table-top device TT and the first table-top device TT1, between the table-top device TT and the second table-top device TT2, and between the table-top device TT and the third table-top device TT3 may be solid lines. A solid line drawn between two table-top devices may indicate that the two table-top devices are directly connected.

Referring to FIG. 4, the connection line drawn between the third table-top device TT3 and the fourth table-top device TT4 may be a dotted line, which indicates that the third table-top device TT3 and the fourth table-top device TT4 are connected, but not directly, via the third table-top device TT3.

That is, a table-top device that is connected to the table-top device TT by a dotted line may be connected to the table-top device, but not directly.

Two table-top devices that are connected by a solid line may be manually connected to or disconnected from each other, whereas two table-top devices that are connected by a dotted line may not be able to be manually connected to or disconnected from each other.

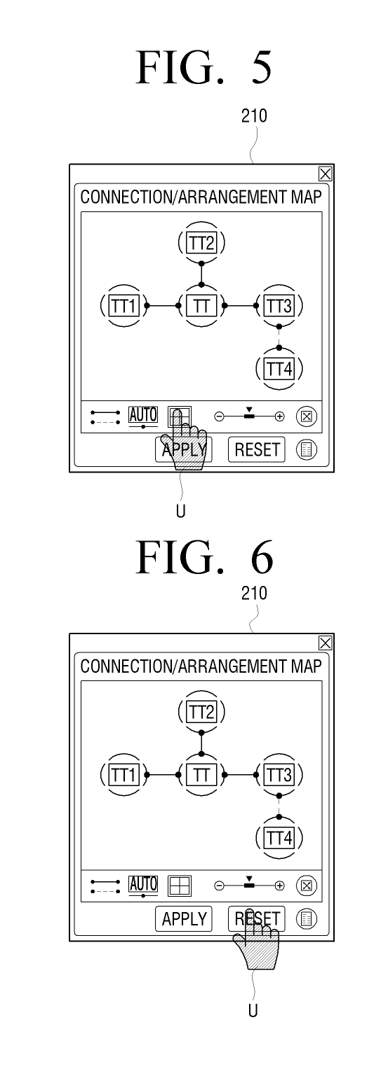

Referring to FIG. 5, in response to an automatic rearrangement icon ( [symbol] ) being pressed by the user U, the table-top devices TT, TT1, TT2, TT3, and TT4 may be automatically rearranged in the connection/arrangement map window 210.

An automatic rearrangement of the table-top devices TT, TT1, TT2, TT3, and TT4 may be performed such that the lengths of the connection lines drawn between the table-top devices TT, TT1, TT2, TT3, and TT4 may be shorter than the previously displayed connection lines between the devices.

As a result of the automatic rearrangement of table-top devices TT, TT1, TT2, TT3, and TT4, a table-top device to which most connection lines are connected (or a table-top device in which the connection/arrangement map window 210 is being executed), i.e., the table-top device TT, may be arranged in the middle; the first table-top device TT1 may be arranged on the west side of the table-top device TT to minimize the connection line drawn between the table-top device TT and the first table-top device TT1; the second table-top device TT2 may be arranged on the north side of the table-top device TT to minimize the connection line drawn between the table-top device TT and the second table-top device TT2; the third table-top device TT3 may be arranged on the east side of the table-top device TT to minimize the connection line drawn between the table-top device TT and the third table-top device TT3; and the fourth table-top device TT4 may be arranged on the south side of the table-top device TT to minimize the connection line drawn between the table-top device TT and the fourth table-top device TT4.

Similarly, a connection/arrangement map that displays the connections between and the arrangement of the table-top devices TT, TT1, TT2, TT3, and TT4 may be provided in the connection/arrangement map window 210.

Referring to FIG. 6, in response to a ‘REPEAT’ icon, which is provided in the connection/arrangement map window 210 for performing an automatic connection resetting function, being pressed by the user U, the connection/arrangement map operations described above may be performed again. As a result of the automatic connection resetting function, any updates in the connections between and the arrangement of the table-top devices 100, 100-1, 100-2, 100-3, and 100-4 may be provided. Accordingly, the automatic connection resetting function may be performed when there is a need to update an existing connection/arrangement map.

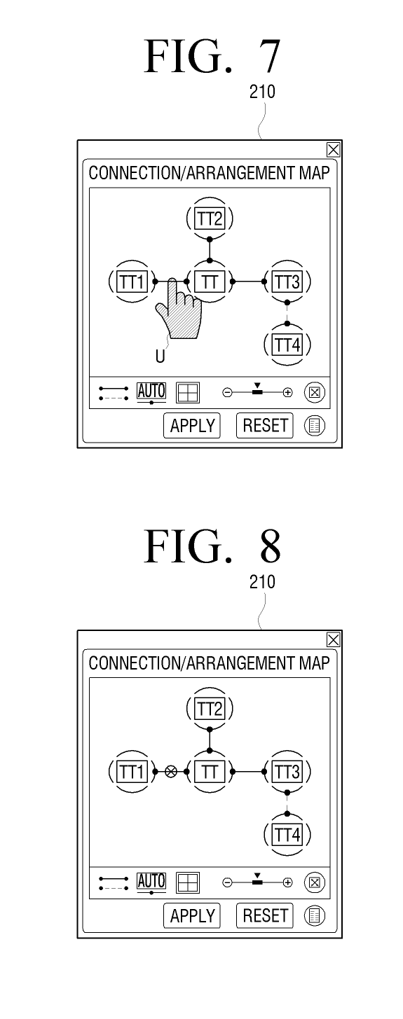

FIGS. 7 to 10 are diagrams illustrating manually disconnecting table-top devices.

Referring to FIGS. 7 and 8, in response to the connection line drawn between the table-top device TT and the first table-top device TT1 being touched by the user U, a ‘disconnect’ icon (□) may be displayed at a location touched by the user U.

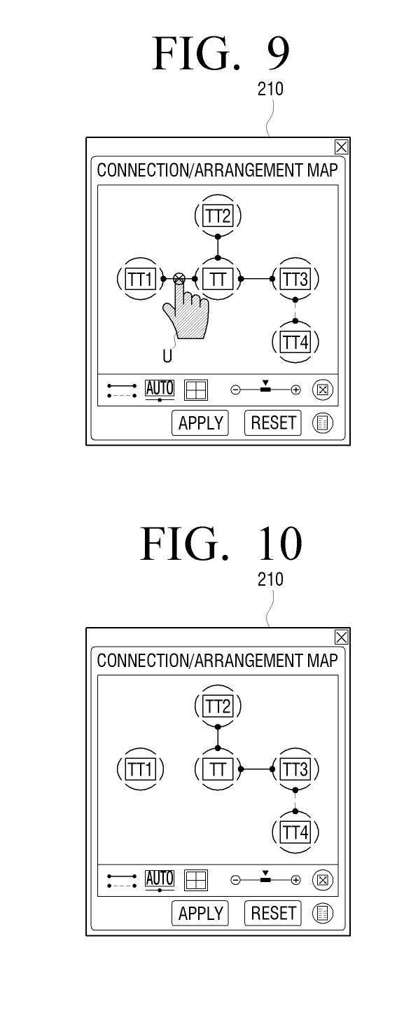

Referring to FIGS. 9 and 10, in response to the ‘disconnect’ icon (□) being touched by the user U, the connection line between the table-top device TT and the first table-top device TT1 may disappear, and the network connection between the table-top device TT and the first table-top device TT1 may be disconnected.

When the user U touches on the connection line between the third table-top device TT3 and the fourth table-top device TT4, no ‘disconnect’ icon (□) may be displayed on the corresponding connection line.

That is, since the connection/arrangement map 210 is being executed by the table-top device TT, but not by the third or fourth table-top device TT3 or TT4, connection settings regarding other table-top devices than the table-top device TT may be prevented from being arbitrarily modified. Accordingly, the network connection between the third table-top device TT3 and the fourth table-top device TT4 cannot be disconnected by using the connection/arrangement map window 210.

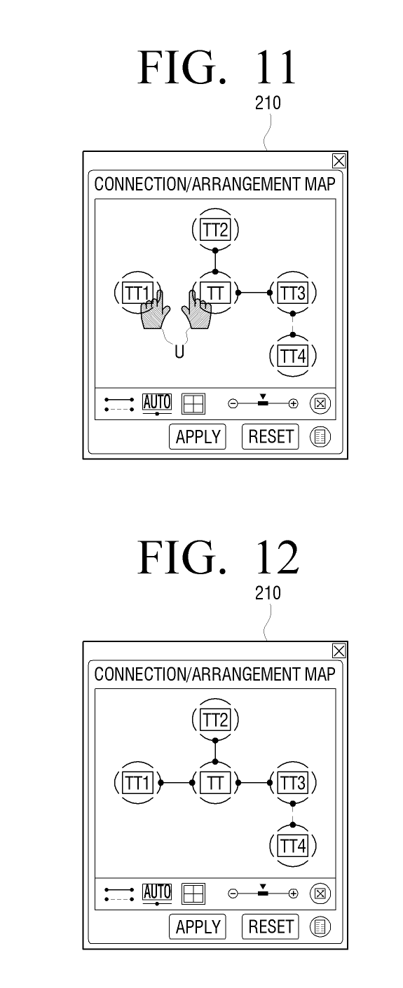

FIGS. 11 and 12 are diagrams illustrating manually establishing a connection between table-top devices.

Referring to FIGS. 11 and 12, in response to both the right outline of the first table-top device TT1 and the left outline of the table-top device TT being touched at the same time by the user U, a connection line may appear between the right outline of the first table-top device TT1 and the left outline of the table-top device TT, and a network connection may be established between the first table-top device TT1 and the table-top device TT.

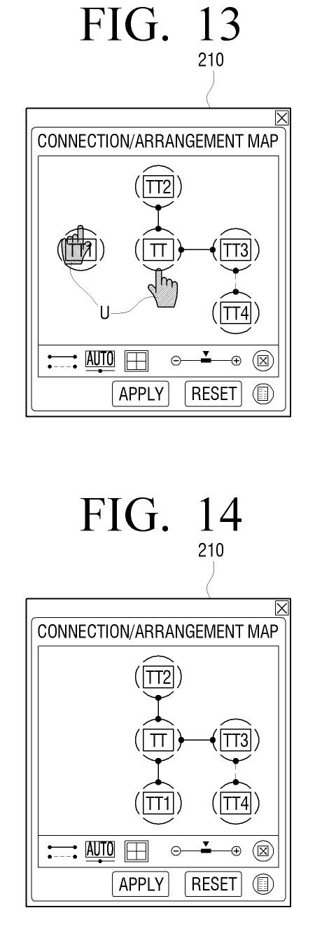

Referring to FIGS. 13 and 14, in response to both the upper outline of the first table-top device TT1 and the lower outline of the table-top device TT being touched at the same time by the user U, the table-top device TT1 may be moved below the table-top device TT, a solid line that connects the upper outline of the first table-top device TT1 and the lower outline of the table-top device TT may be displayed as a connection line, and a network connection may be established between the table-top device and the first table-top device TT1.

The example illustrated in FIGS. 13 and 14 may be performed When the first table-top device TT1 is actually moved to the south of the table-top device TT and its movement is recognized by the user U. Similarly, it is possible to avoid any complexity in a connection resetting process.

As described above, the connection between the third table-top device TT3 and the fourth table-top device TT4, which is represented by a dotted line, cannot be manually disconnected by the user U. In addition, no connection may be manually established between the third table-top device TT3 and the fourth table-top device TT4 by the user U.

The user U may manually rearrange the table-top devices TT, TT1, TT2, TT3, and TT4 in the connection/arrangement map window 210.

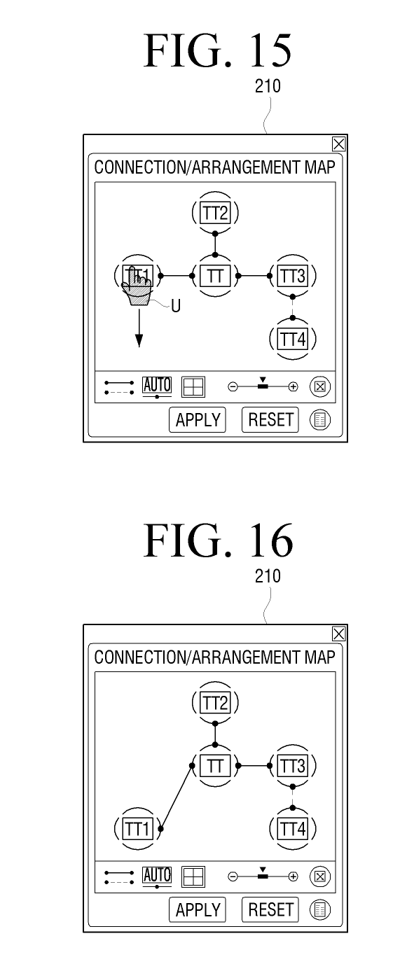

Referring to FIGS. 15 and 16, in response to the user U dragging the first table-top device TT1 and dropping it at a predetermined position, the first table-top device TT1 may be moved to the predetermined position.

The example illustrated in FIGS. 15 and 16 may be performed for precisely reflecting the actual arrangement of the table-top devices TT, TT1, TT2, TT3, and TT4 or for other user convenience-related purposes.

For example, the example illustrated in FIGS. 15 and 16 may be performed to move a table-top device that is less relevant than other table-top devices to a side or corner of the connection/arrangement map window 210.

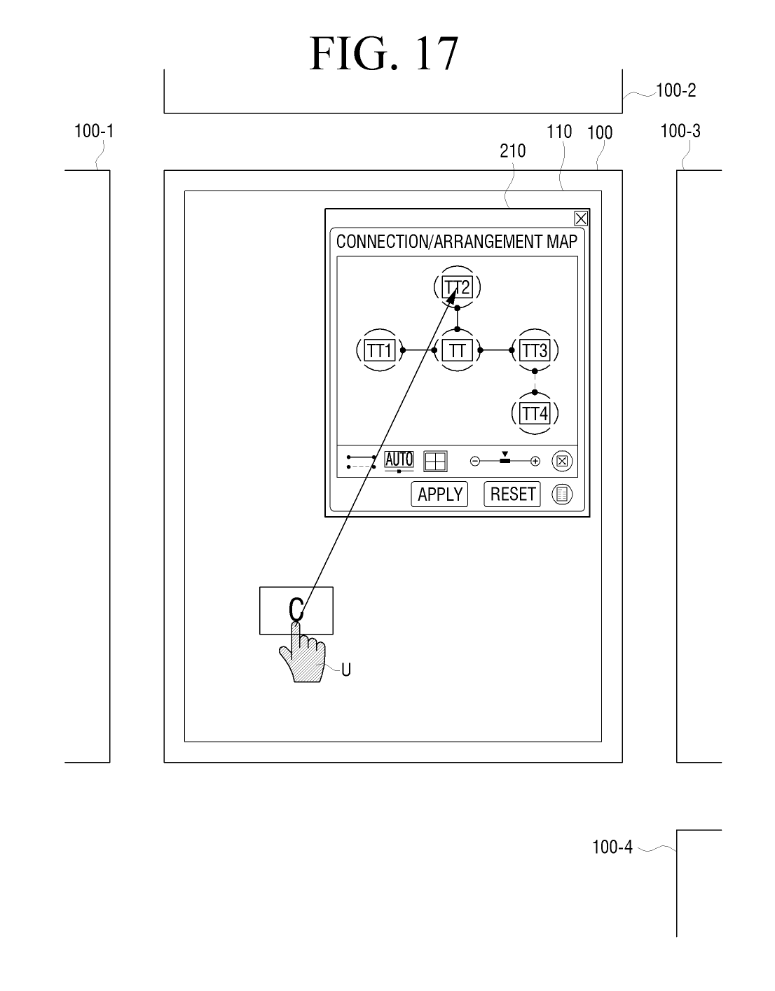

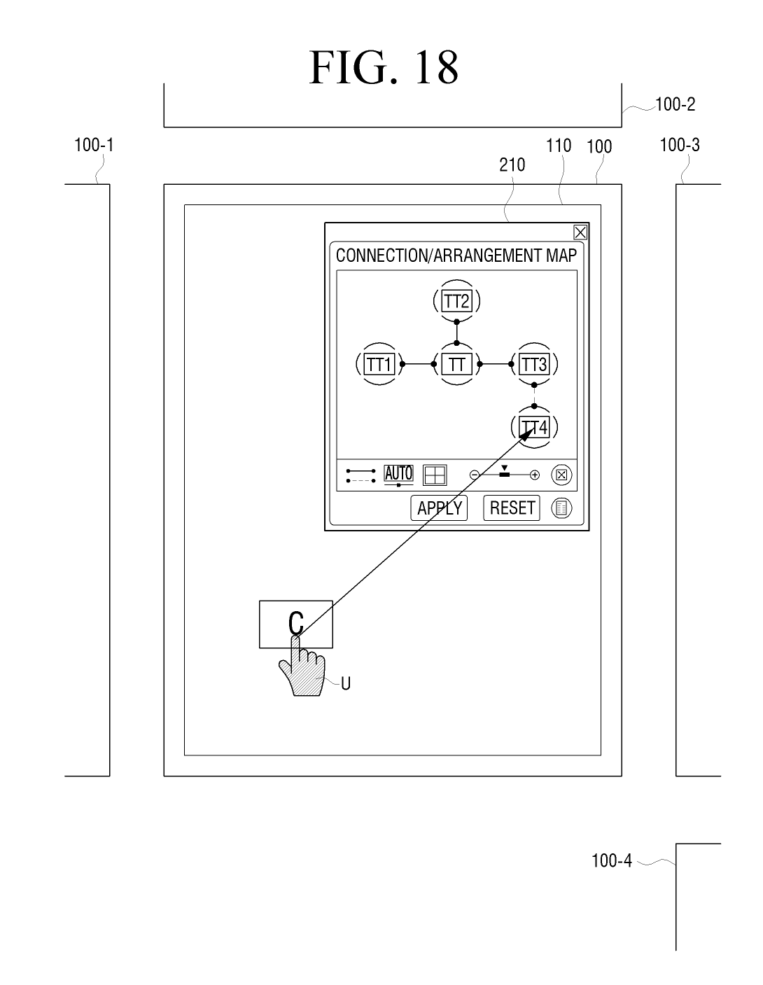

FIGS. 17 and 18 are diagrams illustrating transmitting content using a connection/arrangement map.

Referring to FIG. 17, in response to the user U dragging content C on the touch screen 110 and dropping the content C at the second table-top device TT2 in the connection/arrangement map window 210, the table-top device TT may transmit the content C to the second table-top device TT2.

Referring to FIG. 18, in response to the user U dragging content C on the touch screen 110 and dropping it at the fourth table-top device TT4 in the connection/arrangement map window 210, the table-top device TT may transmit the content C to the fourth table-top device TT4 via the third table-top device TT3.

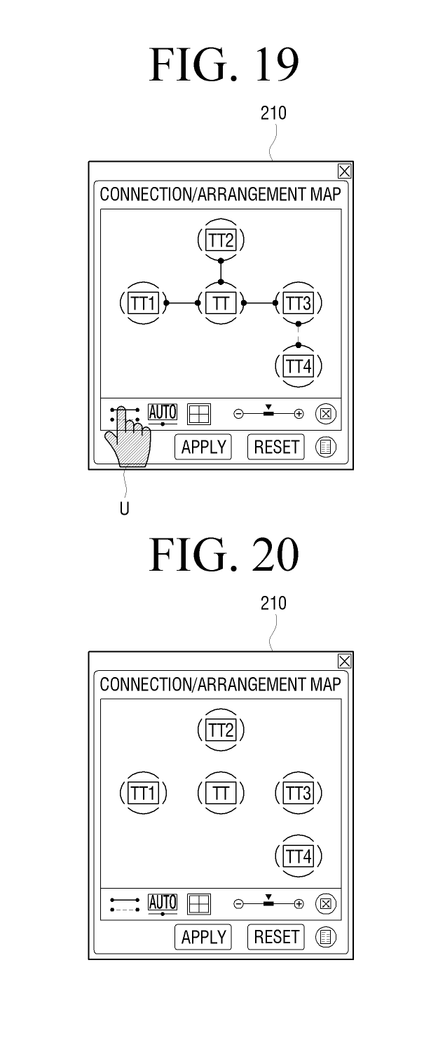

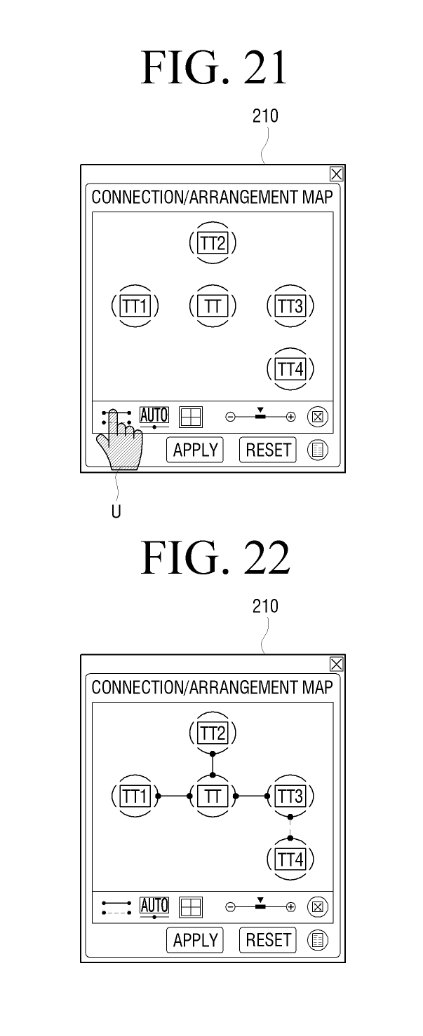

FIGS. 19 to 22 are diagrams illustrating displaying and deleting connection lines.

Referring to FIGS. 19 and 20, in response to the user U touching on an icon (=), which is provided in the connection/arrangement map window 210 for displaying/deleting a connection line, connection lines in the connection/arrangement map window 210 may all disappear.

In this case, in response to the user U touching on the icon (=) again, the connection lines may appear back in the connection/arrangement map window 210, as shown in FIG. 22.

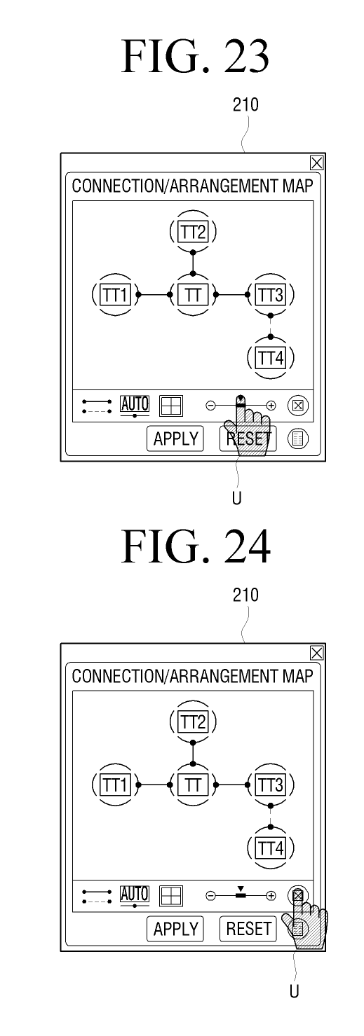

Referring to FIG. 23, the user U may enlarge or reduce the connection/arrangement map window 210 to a desired size by dragging a zoom setting tool in the connection/arrangement map window 210.

Referring to FIG. 24, the user U may automatically adjust the size of the connection/arrangement map window 210 by touching on an automatic adjustment icon in the connection/arrangement map window 210.

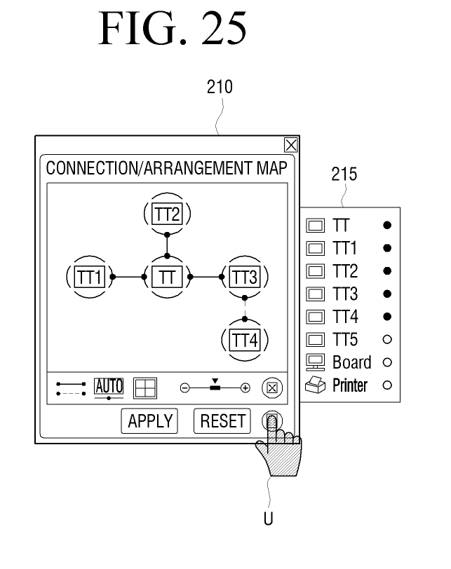

Referring to FIG. 25, the user U may withdraw a connected device list 215 by touching on a list icon (□) in the connection/arrangement map window 210.

The connected device list 215 includes a plurality of devices that are connected to a network. Referring to the connected device list 215, the devices that are currently being displayed on a connection/arrangement map may be marked with “,” and the devices that are currently not being displayed on the connection/arrangement map may be marked with “◯.” Accordingly, the devices that are currently being displayed on a connection/arrangement map may be easily distinguished from the devices that are currently not being displayed on the connection/arrangement map.

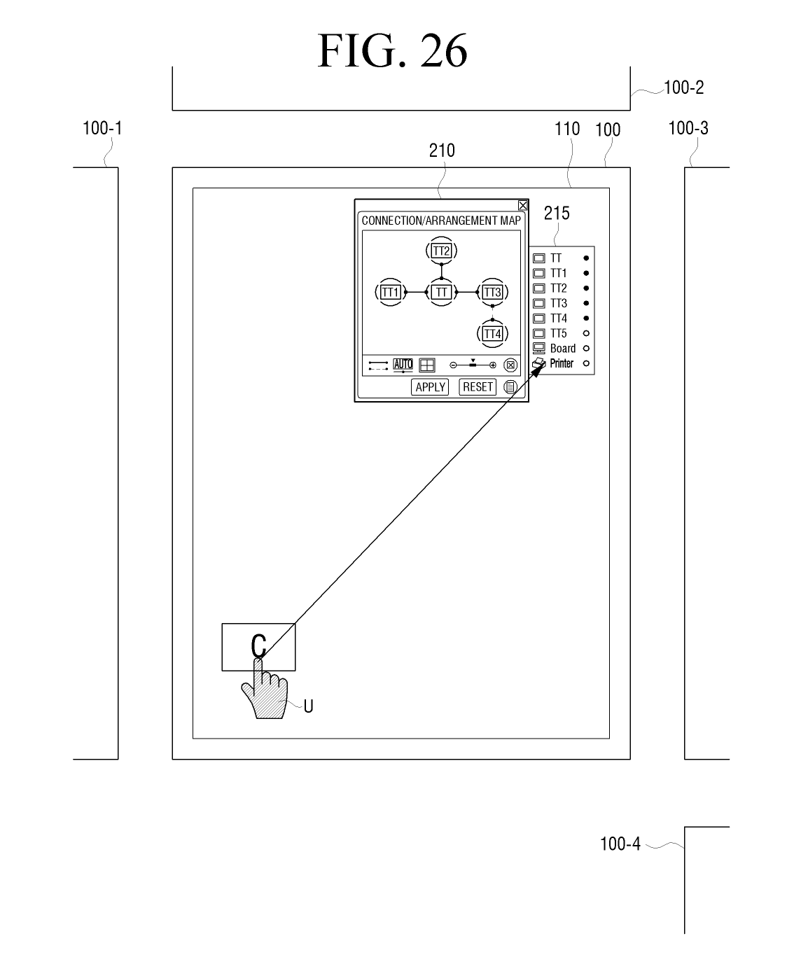

FIG. 26 is a diagram illustrating an example of printing content using the connected device list 215, which is provided along with a connection/arrangement map.

Referring to FIG. 26, in response to the user U dragging content C on the touch screen 110 and dropping the content C at a printer included in the connected device list 215 of the connection/arrangement map window 210, the table-top device TT may transmit the content to the printer together with a ‘print’ command. Accordingly, the printer may print the content C.

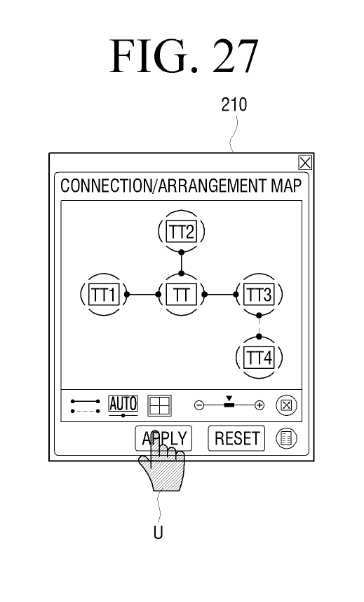

Referring to FIG. 27, the user U may store a connection/arrangement map currently being displayed in the connection/arrangement map window 210 as a file by touching on an ‘APPLY’ icon in the connection/arrangement map window 210. The stored connection/arrangement map may be transmitted to other devices.

In the description above, a connection/arrangement map showing the connections between and the arrangement of table-top devices is provided as one example. Other examples of devices providing a connection/arrangement map may be mobile devices, for example, a mobile phones, MP3 players, digital cameras, mobile Personal Computers (PCs), and the like, and non-mobile devices, for example, electronic frames, Internet Protocol Television (IP TV), desktop PCs, and the like.

The present invention may be applied not only to a group of homogeneous devices that configure a network but also a group of heterogeneous devices that configure a network. For example, the present invention may be applied to a network that is configured by table-top devices and standing-type displays such as smart boards, printers, and the like.

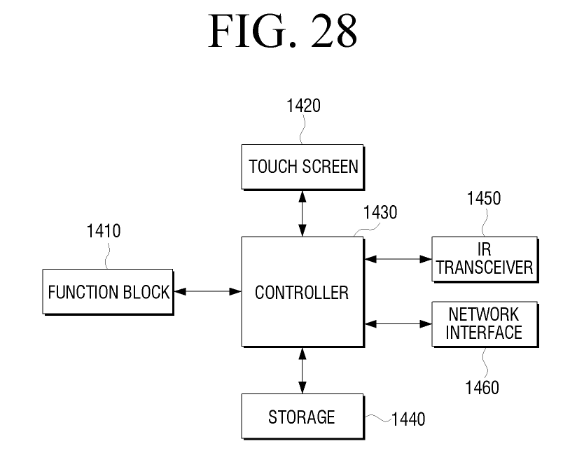

FIG. 28 is a block diagram of a device according to the present invention. Referring to FIG. 28, the device includes a function block 1410, a touch screen 1420, a controller 1430, a storage 1440, an IR transceiver 1450, and a network interface 1460.

The function block 1410 may perform the inherent functions of the device. For example, when the device is a table-top device, the function block 1410 may perform one or more digital conference-related functions. In another example, where the device is a mobile phone, the function block 1410 may perform the functions of a mobile phone.

The touch screen 1420 may perform the functions of a display such as, for example, displaying a connection/arrangement map window 210 and content C, and the functions of a user interface, such as, for example, receiving a user command (for example, a touch, a drag, a drag-and-drop, and the like) in accordance with the results of a function performed by the function block 1410.

The storage 1440 may be a storage medium in which a connection/arrangement map program, a connection/arrangement table, and content may be stored.

The IR transceiver 1450 may perform IR communication, and the network interface 1460 may perform network communication.

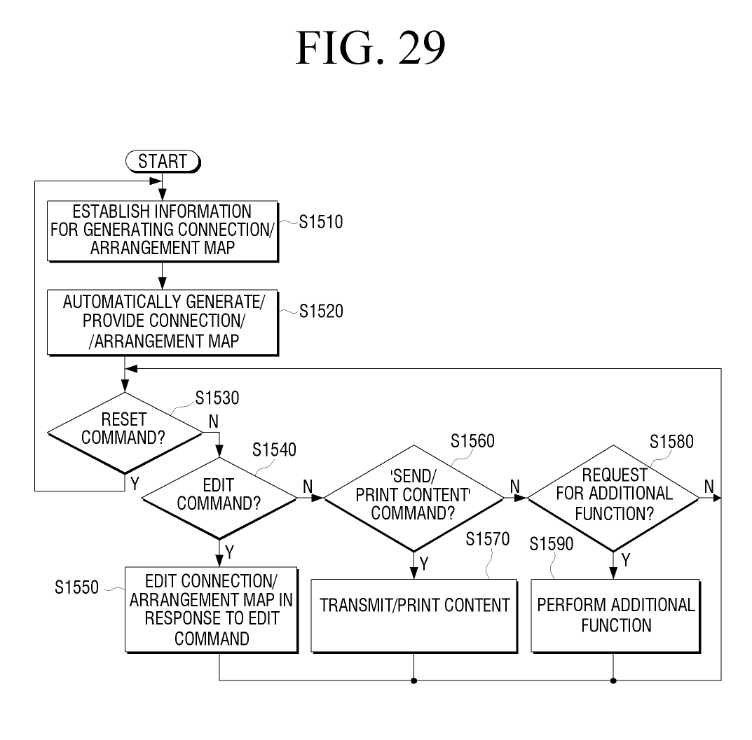

The controller 1430 may perform a method illustrated in FIG. 29, thereby providing a multifunctional connection/arrangement map to a user.

FIG. 29 is a flowchart illustrating a method of providing a multifunctional connection/arrangement map to a user, according to an embodiment of the present invention.

Referring to FIG. 29, the controller 1430 may establish information for generating a connection/arrangement map in Step 1510, may automatically generate a connection/arrangement map, and may provide the generated connection/arrangement map to a user in Step 1520.

In response to a ‘reset’ command being received from the user in Step 1530-Y, the method returns to operation S1510 so that the controller 1430 may perform S1510 and S1520 again.

In response to an ‘edit connection/arrangement map’ command being received from the user in Step 1540-Y, the controller 1430 may edit the generated connection/arrangement map in accordance with the ‘edit connection/arrangement map’ command in Step 1550. For example, the editing of the generated connection/arrangement map may include manually disconnecting the connections between devices shown in the generated connection/arrangement map, manually establishing connections between the devices, and manually repositioning the devices.

In response to a ‘transmit content’ command or a ‘print’ command being received from the user via the generated connection/arrangement map in Step 1560-Y, the controller 1430 may transmit or print content in Step 1570.

In response to a request for an additional function being issued by the user in Step 1580-Y, the controller 1430 may perform the requested additional function in Step 1590. For example, the requested additional function may include displaying/deleting connection lines, enlarging/reducing the generated connection/arrangement map, providing a connected device list, and storing the generated connection/arrangement map.

In the examples described above, the IR transceivers 150-1 to 150-4, 150-13, 150-24, 150-31, 150-34, and 150-42 are used to locate the table-top devices 100, 100-1, 100-2, 100-3, and 100-4.

Since IR communication is a form of directional communication, the IR transceivers 150-1 to 150-4, 150-13, 150-24, 150-31, 150-34, and 150-42 may be replaced by other communication devices with directivity.

For example, the IR transceivers 150-1 to 150-4, 150-13, 150-24, 150-31, 150-34, and 150-42 may be replaced by speaker-and-microphone devices with directivity, ultrasonic transceivers with directivity, or Radio Frequency (RF) transceivers with directivity that can transmit and receive IDs to and from one another when facing one another.

Where a table-top device is faced by another table-top device with a highest received signal strength level, it may locate its neighboring table-top device with a communication device with weak directivity or even without directivity.

The exchange of IDs between table-top devices may be performed through network communication. Here, the IR transceivers of the table-top devices may sequentially issue an ID request to their respective neighboring table-top devices. In response to the receipt of an ID request, the IR transceivers of the table-top devices may transmit their IDs via a network.

For example, when the IR transceiver 150-1 of the table-top device 100 issues an ID request through IR communication, the IR transceiver 150-13 of the first table-top device 100-1 may transmit ID_#1 to a network. In response to the receipt of ID_#1 via the network, the table-top device 100 may identify that the table-top device on the opposite side thereof, i.e., the table-top device located on the west side thereof, is a table-top device with ID_#1, i.e., the first table-top device 100-1.

Various information, other than ID information, may be exchanged between the table-top devices. For example, table-top devices may exchange their Signal-to-Noise ratio (S/N) information or network addresses with one another.

As described above, according to the present invention, it is possible to easily and intuitively identify the connections between and the arrangement of devices that are connected to a network by using a GUI that displays the connections between and the arrangement of the devices. In addition, it is possible to easily connect and disconnect devices that configure a network and to intuitively transmit content between the devices.

While the present invention has been shown and described with reference to various embodiments thereof, the present invention can be readily applied to other types of apparatuses. The description of the various embodiments is intended to be illustrative, and it will be apparent to those of ordinary skill in the art that various changes in form and detail can be made without departing from the spirit or scope of the present invention, defined by the appended claims.

1. A method of providing a Graphic User Interface (GUI), the method comprising:
determining connections between a plurality of devices and arrangement of the plurality of devices;
generating a GUI that displays the devices, the connections between the devices and the arrangement of the devices; and
displaying the generated GUI.

2. The method of claim 1, wherein the connections between the plurality of devices include connections between a predetermined device and a direct neighboring device of the predetermined device and connections between a direct neighboring device and a neighboring device of the direct neighboring device, and the arrangement of the devices includes the arrangement of the predetermined device, the direct neighboring device of the predetermined device, and the neighboring device of the direct neighboring device.

3. The method of claim 1, wherein generating the GUI comprises:
displaying the devices;
displaying connection lines between the devices based on the connections between the devices and relative to the arrangement of the devices; and
repositioning the devices such that the connection lines between the devices become shorter than the previously displayed connection lines between the devices.

4. The method of claim 3, wherein the connection line connects a pair of devices by connecting facing sides of the pair of devices.

5. The method of claim 3, wherein the connection lines for a direct connection to the predetermined device is displayed differently from a connection lines for an indirect connection to the predetermined device.

6. The method of claim 3, wherein repositioning the devices comprises:
positioning a predetermined device that most of the connection lines are drawn from in the middle of the GUI; and
repositioning other devices such that connection lines between the predetermined device and the other devices are shorter than the previously displayed connection lines between the devices.

7. The method of claim 1, further comprising:
deleting a connection line selected by a user; and
manually disconnecting a connection between the devices connected by the deleted connection lines.

8. The method of claim 7, wherein deleting the connection line comprises deleting the connection lines between a predetermined device and a device directly connected to the predetermined device.

9. The method of claim 1, further comprising:
displaying a connection line between devices selected by a user; and
setting a connection between the selected devices.

10. The method of claim 1, further comprising:
in response to content dragged and dropped at one of the devices, transmitting the content to the device at which the content is dropped.

11. The method of claim 10, wherein transmitting the content to the device comprises, when the device at which the content is dropped is indirectly connected through another device, transmitting the content to the device at which the content is dropped via the another device.

12. The method of claim 1, further comprising:
in response to receiving a “reset” command, repeating performing determining the connections, generating the GUI, and displaying the GUI.

13. The method of claim 1, wherein determining connections between a plurality of devices comprises:
receiving by a predetermined device information on a neighboring device via different sides of the neighboring device and determining the orientation of the neighboring device and the arrangement of the neighboring devices based on the received information.

14. A device for providing a Graphic User Interface (GUI) comprising:
a controller, for determining connections between a plurality of devices and arrangement of the plurality of devices, generating a GUI that displays the plurality of devices, the connections between the devices and the arrangement of the devices; and
a display, for displaying the generated GUI.

15. The device of claim 14, wherein the connections between the plurality of devices include connections between a predetermined device and a direct neighboring device of the predetermined device and connections between a direct neighboring device and a neighboring device of the direct neighboring device, and the arrangement of the devices includes the arrangement of the predetermined device, the direct neighboring device of the predetermined device, and the neighboring device of the direct neighboring device.

16. The device of claim 14, wherein generating the GUI by the controller comprises displaying the devices and the respective connection lines between the devices based on the connections between the devices and relative to the arrangement of the devices and repositioning the devices such that the connection lines between the devices become shorter than the previously displayed connection lines between the devices.

17. The device of claim 16, wherein the connection line connects a pair of devices by connecting facing sides of the pair of devices, and the connection line for a direct connection to the predetermined device is displayed differently from a connection line for an indirect connection to the predetermined device.

18. The device of claim 16, wherein repositioning the devices by the controller comprises positioning a predetermined device that most of the connection lines are drawn from in the middle of the GUI; and repositioning other devices such that connection lines between the predetermined device and the other devices are shorter than the previously displayed connection lines between the devices.

19. The device of claim 14, wherein the controller, in response to content dragged and dropped at one of the devices on the display, controls transmitting the content to the device at which the content is dropped.

20. The device of claim 14, wherein the controller determines connections between a plurality of devices based on information received by a predetermined device on a neighboring device via different sides of the neighboring device and determines the orientation of the neighboring device and the arrangement of the neighboring device based on the received information.
